(19) United States
(12) Patent Application Publication
(10) Pub. No.: US 2009/0155920 A1
(43) Pub. Date: Jun. 18, 2009

(54) HIGH THROUGHPUT DISSOLUTION AND PRECIPITATION APPARATUS AND METHOD

(75) Inventor: Eric D. Carlson, Cupertino, CA (US)

Correspondence Address: SENNIGER POWERS LLP (SMX), 100 NORTH BROADWAY, 17TH FLOOR, ST. LOUIS, MO, 63102, US

(73) Assignee: SYMYX TECHNOLOGIES, INC., Sunnyvale, CA (US)

(21) Appl. No.: 12/269,508

(22) Filed: Nov. 12, 2008

Related U.S. Application Data
(60) Provisional application No. 60/987,158, filed on Nov. 12, 2007.

(51) Int. Cl. G01N 21/00; G01N 21/75; G01N 31/02; G01N 1/18

(52) U.S. Cl. 436/164; 422/101; 422/82.05; 436/177; 436/178

(57) ABSTRACT

A dissolution and precipitation system includes an array of reactors. Each reactor has a mother well and a daughter well having a volume between about one microliter and one milliliter. A fluid transfer system is operable to transfer fluid between the mother well and daughter well and purify the fluid that is transferred to the daughter well from the mother well. A method of testing a plurality of samples includes dissolving a plurality of first solids in each of the mother wells to form a plurality of first solutions in the mother wells. The first solutions are purified in the reactors. The first solutions are distributed from the mother wells to one or more daughter wells. A plurality of second solids are precipitated in the daughter wells and the second solids are analyzed.

### CROSS REFERENCE TO RELATED APPLICATION

This application claims priority to U.S. provisional application No. 60/987,158, filed Nov. 12, 2007, the entire contents of which are hereby incorporated by reference.

### FIELD OF THE INVENTION

This invention relates to precipitation from liquid solutions. More particularly, this invention relates to high throughput apparatus and methods directed toward controlled dissolution and precipitation of small quantities of solids using small quantities of materials.

### BACKGROUND

Solids such as metals, ceramics, organic solids and the like can be designed to have desired properties. While many of these properties depend upon the chemical composition of the material, other properties depend upon the specific crystallographic structure (or amorphous structure, as the case may be) of the material. Two chemically identical compounds may have slightly different crystallographic structures, notwithstanding their identical chemical composition. These structural differences may result in very different interactions with (or responses to) the surrounding environment. For example, the bioavailability and stability of pharmaceutical active compounds can vary depending on crystal structure.

As a result of these non-chemical differences, many important materials are characterized by a variety of factors beyond their chemical compositions, including but not limited to: grain size, phase assemblage, crystal structure, band structure, magnetic polarization, ferroic domain size, and many other characteristics. Two materials having ostensibly identical chemical compositions, but differing in crystal structure, can be called polymorphs of each other; and a group of these materials, can be called a family of polymorphs. An additional polymorph for an existing family is typically discovered post-situ, after the material has been synthesized and it has been determined that its crystal structure differs from the structures of the existing family members. While the desired properties of an engineered material may be known, the specific polymorph that might yield these properties is typically unknown a priori. As a result, many scientists attempt to synthesize as many different polymorphs in a given family as possible, in hopes that at least one polymorph will yield desired properties.

However, the environmental factors that result in the crystallization of one polymorph (rather than another) can be complex and are generally a function of both thermodynamic and kinetic factors. These environmental factors can include (but are not limited to) cooling rate, nucleation agent, reagent purity and history, containment properties, thermal history, order of addition of components, agitation, radiation exposure, electric field, magnetic field, and many other factors. Thus, creating a diverse family of polymorphs often requires creating a wide range of different precipitation environments, precipitating solids within these environments, and determining if any of the environments has created a new polymorph. Environmental differences may result from (but are not limited to): (1) choices of components that may putatively act as: (a) primary solvent, (b) ancillary solvent, (c) antisolvent, (d) counter-ion, (e) nucleation agent or (f) other chemical component; (2) choice of cooling rate, (3) choice of containment materials, (4) choice of heterogeneous nucleation agents, (5) choice of thermal history, (6) choice of radiative treatment, (7) choice of agitation schedule, and (8) choice of many other factors. The process of creating these myriad environments, precipitating solids within them, and evaluating the structure of the solids, can be tedious, time consuming, and require the use of large amounts of expensive chemical components.

Pharmacological compounds can be materials in which a specific polymorph may have superior properties to other members of the same family. Dissolving different members of the same family of polymorphs can yield the same components, which in the case of pharmacological materials may include an active pharmacological ingredient (API). However, for reasons including, but not limited to, manufacturability, thermal stability, bioavailability, dissolution kinetics and the like, manufacturers of pharmacological compounds may seek to make a specific member of a family of polymorphs. An industry journal published an entire special issue on this topic, Organic Process Research and Development (Volume 4, No. 5, 2000). International patent application WO 03/014732 and U.S. Published Patent App. No. 20030124028 describe several important aspects related to the discovery of novel polymorphs and are each incorporated in their entirety herein by reference.

As a result, pharmacological scientists seeking to precipitate a polymorph with superior properties require a methodology and apparatus for rapidly synthesizing many ostensibly diverse samples, under controlled, possibly diverse precipitation conditions, using a minimum quantity of API, in a minimum amount of time, and measuring relevant properties of these samples.

Performing these studies has historically required many steps with separate pieces of equipment. A workflow might require separate equipment to deliver both solids and liquids to a reactor, react solids and solvents for extended periods of time, filter the solutions to remove heterogeneous nucleants, subject the filtered solution to a diverse range of precipitation conditions, remove the precipitate, and analyze the precipitate. Additionally, transfer of samples between pieces of equipment can require complex automation or manual labor, and commonly involves the loss of a quantity of solid or liquid sample material at each transfer step. This loss of sample during transfer can be particularly problematic as sample sizes are reduced from the scale of classic laboratory experiments (e.g. tens of milliliters) to the smaller scales (e.g., the microliter scale). For example, filtering a 100 microliter volume of solution can result in more solution being absorbed by the filter than is delivered through the filter.

Additionally, each sample transfer step creates the opportunity for contamination, which can affect subsequent precipitation in unknown ways. As a result, the exact reasons for precipitation of one polymorph over another may not be understood if the equipment or methods have introduced contaminants into the sample solution.

### SUMMARY

One aspect of the present invention is a system comprising an array of reactors, each of which comprises at least two wells, a mother well and a daughter well. The system is suitable for the high throughput synthesis and screening of small quantities of solids precipitated from small volumes of liquids. Arrays of reactors provide the ability to efficiently create a plurality of diverse precipitation conditions. Each reactor includes apparatus to receive solids and liquids, dissolve the solids, filter the solution, and subject the filtered and unfiltered solution to diverse experimental conditions. The precipitated solids subsequently may be efficiently analyzed in-situ, using a variety of methods.

Another aspect of the invention is a dissolution and precipitation system comprising an array of reactors. Each reactor includes: (a) a mother well having a volume between one microliter and one milliliter, a closed bottom and sides, and an access port; (b) one or more daughter wells each having a volume between one microliter and one milliliter, a closed bottom and sides, and an access port; (c) one or more fluid flow passages connecting the mother well to the one or more daughter wells, each fluid flow passage having an opening in each of the wells connected by the fluid flow passage; (d) a filtering system associated with each fluid flow passage to filter fluids passing between the wells connected by the fluid flow passage; and (e) a fluid control mechanism associated with each fluid flow passage capable of controlling the flow of liquids (and optionally controlling flow the flow of gases) between the wells connected by the fluid flow passage.

Another aspect of the invention is a method for dissolving, precipitating, and analyzing a solid. The method includes i) providing an array of reactors, each reactor including a mother well having a volume between one microliter and one milliliter, a closed bottom and sides, and an access port, and ii) one or more daughter wells, each having volume between one microliter and one milliliter, a closed bottom and sides, and an access port, (iii) providing a first solid to each mother well, (iv) dissolving the first solid in a sufficient amount of a first solvent to form a solution, (v) flowing at least a portion of the solution from each of the mother wells to at least one daughter well via a fluid flow passage providing fluid communication between the mother well and the daughter well, (vi) filtering the portion during the flowing step, (vii) precipitating a second solid in one or more of the mother wells and/or daughter wells by a process selected from the group consisting of: evaporation of the first solvent, application of a cooling protocol, instantaneous addition of an anti-solvent, slow addition of a precipitating component via diffusion into the well from a source outside the well, and combinations thereof, and (viii) analyzing the contents of the daughter well and optionally the mother well using one or more of radiation, microscopy, Raman, and X-ray diffraction (XRD).

Yet another aspect of the invention is a dissolution and precipitation system comprising an array of reactors. Each reactor includes a mother well and a daughter well having a volume between about one microliter and one milliliter. A fluid transfer system is operable to transfer fluid between the mother well and daughter well and purify the fluid that is transferred to the daughter well from the mother well.

One embodiment of the invention is a method of testing a plurality of samples in a plurality of reactors. Each reactor has a mother well and one or more daughter wells adapted to receive a fluid from the mother well. The method includes dissolving a plurality of first solids in each of the mother wells to form a plurality of first solutions in the mother wells. At least portions of the first solutions are purified in the reactors. The first solutions are distributed from the mother wells to one or more daughter wells. The one or more daughter wells have a volume between about 1 microliter and 1 milliliter, respectively. A plurality of second solids are precipitated in the daughter wells. The second solids are analyzed.

Other objects and features will in part be apparent and in part pointed out hereinafter.

### BRIEF DESCRIPTION OF DRAWINGS

FIG. 1 is a perspective of one embodiment of a reactor system of the present invention;

FIG. 2 is a schematic diagram of one embodiment of a reactor that is suitable for use in the reactor system;

FIGS. 3A, 3B and 3C are schematic diagrams of three different reactors of the present invention (which are suitable for use in the reactor system) illustrating three different embodiments of a filtration mechanism;

FIGS. 4A, 4B, 4C, 4D and 4E are schematic diagrams of five different wells of the present invention (which are suitable for use in the reactor system) illustrating five different embodiments of a fluid flow passage;

FIGS. 5A, 5B, 5C, 5D, 5E and 5F are schematic diagrams of five different wells of the present invention (which are suitable for use in the reactor system) illustrating five different embodiments of a well access port;

FIGS. 6A, 6B, 6C, 6D, 6E, 6F and 6G are schematic diagrams of six different embodiments of flow control devices of the present invention that are suitable for controlling flow of fluid in the reactor system;

FIGS. 7A and 7B are schematic diagrams of one embodiment of a reactor of the present invention (which is suitable for use in the reactor system) having multiple daughter wells;

FIGS. 8A and 8B are schematic diagrams of another embodiment of a reactor of the present invention (which is suitable for use in the reactor system) having multiple daughter wells;

FIGS. 9A, 9B and 9C are schematic diagrams of three different embodiments of wells of the present invention (which are suitable for use in the reactor system) that have a substantially transparent window for analysis of materials in the wells;

FIG. 10 is a schematic diagram of a portion of one embodiment of a reactor of the present invention (which is suitable for use in the reactor system) that has diffusion well; and

FIG. 11 is a schematic diagram of one embodiment of a reactor of the present invention (which is suitable for use in the reactor system) that has several daughter wells connected in series.

Corresponding reference characters indicate corresponding parts throughout the drawings.

### DETAILED DESCRIPTION

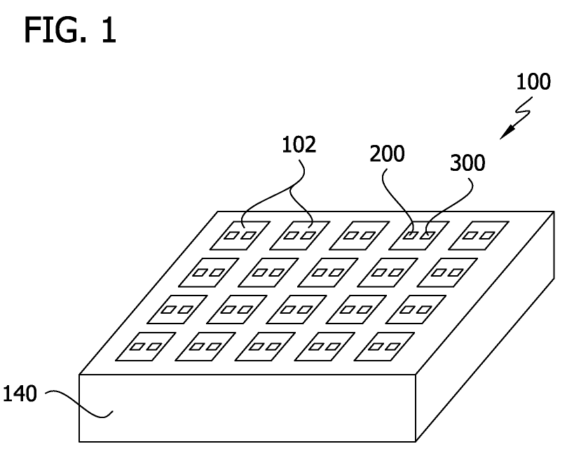

FIG. 1 shows one embodiment of a system 100 of the present invention. The system includes a plurality of discrete reactors 102 arranged in an array and supported by a common support structure (e.g., a block as illustrated). FIG. 1 shows a system comprising 20 reactors 102 in a 5 by 4 array. However, the number of reactors 102 can be varied to suit the needed throughput of the system and the diversity of desired precipitation conditions. For example, the number of reactors 102 is suitably at least 10, more suitably at least 100, and even more suitably at least 500. Generally, each reactor 102 is capable of receiving a quantity of 5 mg or less of a first solid, receiving a quantity of 800 microliters or less of a putative solvent, dissolving the solid to form a saturated solution, purifying at least part of the solution, and precipitating a variety of second solids for analysis. Diverse combinations of experimental conditions can be created in the reactors 102 to assess the impact of the various experimental conditions on the solids produced by the reactor system 100.

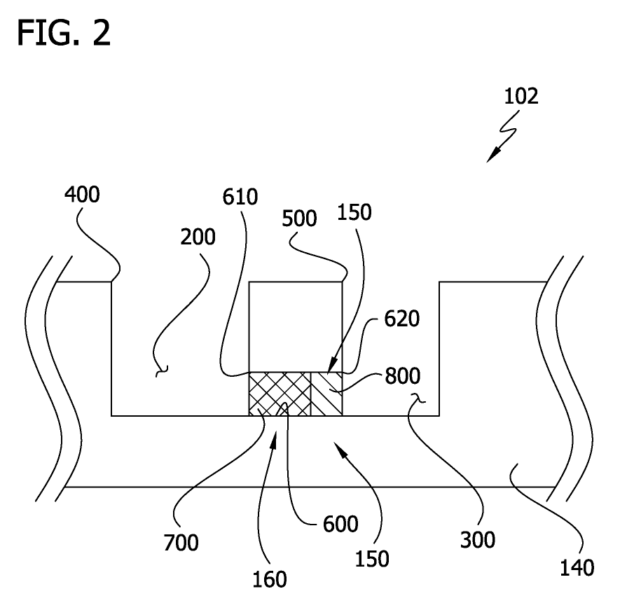

FIG. 2 shows one embodiment of a reactor 102. The reactor 102 includes a mother well 200 and at least one daughter well 300. Multiple daughter wells are possible, but for simplicity the reactor illustrated in FIG. 2 has only one daughter well. The wells 200, 300 are described as “mother” and “daughter” for methodological convenience, and such designations are not intended to be limiting. The mother well 200 typically receives the first solid and provides an environment in which the solid can be at least partially dissolved with a putative solvent. At least some of the resulting solution is transferred to the daughter well 300. A solution may be distributed from a single mother well to several different daughter wells and subjected to a variety of different precipitation protocols in the daughter wells. This can help ensure that any differences in the samples precipitated in the daughter wells are the result of the precipitation protocol and not unintentional differences in the way the solution was prepared in the mother well.

In the illustrated embodiment, both wells 200, 300 are capable of receiving solids and/or liquids through access ports 400 and 500, respectively. The reactor 102 includes a fluid transfer system 150 operable to transfer fluid between the mother well 200 and the daughter well 300 (e.g., via a fluid flow passage 600). The fluid transfer system 150 is suitably operable to purify fluid that is transferred to the daughter well 300.

There are various ways to make reactor systems within the scope of the invention. For example, it may be convenient and efficient to fabricate components of any reactor, an entire reactor, components of the system, or even the entire system, from a single wafer (e.g. of Silicon) or other planar substrate using masking, lithography, etching, deposition, polishing, spin coating, and other methods typical of the semiconductor industry. Methods and apparatus for such fabrication are described in ISBN 0-7803-1085-3 (Micromechanics and MEMS, Classic and Seminal Papers to 1990, edited by Trimmer), ISBN 0849308267 (Fundamentals of Microfabrication, edited by Madou), ISBN 1-58053-343-4 (Fundamentals and Applications of Microfluidics, edited by Nguyen and Werely) and ISBN-13 978-0-19-856864-3/ISBN-100-19-856864-9 (Introduction to Microfluidics, Tabeling and Chen), all of which are incorporated in their entirety herein by reference.

Fluid flow passages between the wells of a reactor can be fabricated using a variety of methods, including machining, molding, forming, stamping, pressing and other typical fabrication methods. Fluid flow passages may also be fabricated separately and combined with wells. For selected reactors, it may be convenient and efficient to fabricate the fluid flow passages using semiconductor manufacturing equipment and methods. In view of the foregoing, the skilled person will appreciate that there are numerous possible configurations for reactors and reactor systems within the scope of the invention.

The reactors 102 of the system 100 in FIG. 1, for example, each include a plurality of wells 200, 300 formed in a common substrate 140 (e.g., a semiconductor wafer). The wells 200, 300 of each reactor 102 are fluidicly coupled by a fluid flow passage 600 (e.g., a conduit), which provides fluid communication between the wells via an opening 610 in the mother well and an opening 620 in the daughter well. The flow control system 170 in FIG. 2 includes a valve 800 (e.g., a MEMS valve or any other suitable valve) positioned to selectively allow flow of fluid through the passage 600 between the wells 200, 300 or block flow of fluid through the passage.

The fluid transfer system 150 is suitably operable to purify the liquid without removing the liquid from the reactor 102. Purification in this application refers to substantial removal of particles or other contaminants (i.e., materials that might have undesirable effects on subsequent precipitation reactions) from the fluid transferred to the daughter well 300. In FIG. 2, the fluid transfer system 150 includes a filter 700 positioned to filter fluid transferred to the daughter well 300 from the mother well 200. The filter 700 is suitably operable to remove at least 90 percent of the particles or other contaminants, more suitably at least 95 percent of the particles or other contaminants, and still more suitably at least 99 percent of the particles or other contaminants.

The filter 700 can be made from a variety of materials, including combinations of materials. The filter 700 can be designed to filter out solid particles, to adsorb or absorb specific chemicals, or otherwise purify the solution as it passes through the filter. Frits, fibrous materials (e.g. papers), foams, or even nanotubes can be used as filter materials. Semipermeable membranes can also be used as filter materials. The filter can comprise a solid phase extraction device or other device that relies on affinity of the device for constituents that are to be removed from the fluid instead of pore size to filter the fluid. For embodiments in which the fluid flow passage 600 is fabricated using semiconductor manufacturing methods, it may also be convenient to fabricate the filter 700 using similar methods. For example, if semiconductor manufacturing equipment is capable of defining feature sizes smaller than the size of the particles to be filtered, a porous filter can be fabricated in the passage 600 by the semiconductor manufacturing methods.

The size of each reactor of the system depends in part upon the number of daughter wells in the reactor. Not only do the daughter wells 300 occupy space themselves, the size of the mother well 200 may also need to be increased so the mother well has the capacity to supply each of multiple daughter wells with the desired amount of fluid. The size of each daughter well 300 can vary depending on the amount of sample required for a desired characterization or analytical method. In general, it is preferable to avoid making the daughter well 300 substantially larger than is required to precipitate the minimum amount of material needed to perform the desired sample analysis because this can help conserve sample materials and limit the spatial footprint of the reactor system 100. Commercial X-ray diffraction equipment (i.e. non-synchrotron sources) can acquire data of reasonable quality in a few minutes per sample with sample sizes of approximately 0.25 mg. Suppliers of such equipment include Bruker AXS (Madison, Wis.), Panalytical B.V. (Almelo, The Netherlands) and Rigaku (Tokyo, Japan). Analytical methods capable of using smaller amounts of sample (e.g. 0.05 mg of solid or even 0.005 mg of solid) are disclosed in U.S. Pat. No. 6,157,449 and international patent application WO 03/014732, both of which are incorporated in their entirety herein by reference. More powerful or more advanced analytical equipment may provide data of sufficient quality using smaller samples without unduly long measurement times.

Each daughter well 300 suitably has a volume between about 1 microliter and 1 milliliter, more suitably a volume between about 10 microliters and 200 microliters, and yet more suitably between about 20 microliters and 100 microliters. Each daughter well 300 suitably has a working volume (i.e., a volume below a fill level that leaves a reasonable amount of freeboard in the well above the fill level) capable of receiving a volume of solution between about 0.8 microliters and 800 microliters, more suitably between about 8 microliters and 160 microliters, and yet more suitably between about 16 microliters and 80 microliters.

The volume of the mother well 200 should be at least as large as the combined volume of solution to be distributed to the daughter well(s) 300. For example, each mother well 200 suitably has a volume between about 1 microliter and 1 milliliter, more suitably between about 10 microliters and 200 microliters, and yet more suitably between about 20 microliters and 100 microliters. Each mother well 200 suitably has a working volume capable of receiving a volume of solution between about 0.8 microliters and 800 microliters, more suitably between about 8 microliters and 160 microliters, and yet more suitably between about 16 microliters and 80 microliters. Each mother well 200 is suitably further capable of receiving a quantity of solid between about 0.005 mg and 5 mg, more suitably between about 0.05 mg and 1 mg, and yet more suitably between about 0.1 mg and 0.5 mg.

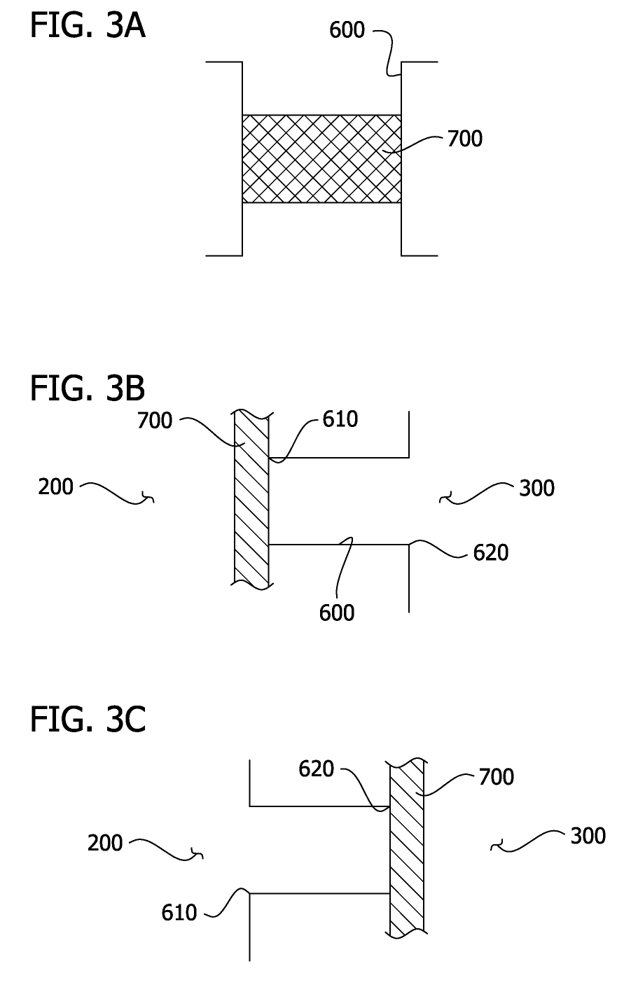

FIGS. 3A-3C show three different examples of how the filter 700 of the fluid transfer system 150 can be positioned in the reactor 102 to purify the fluid (e.g., a solution) transferred to the daughter well 300. Referring to FIG. 3A, the filter 700 is disposed within the fluid flow passage 600 between the mother well 200 and daughter well 300. Although FIG. 3A illustrates the filter 700 positioned within a vertically oriented segment of the passage 600, it is understood that the filter could be installed in the passage in a similar manner regardless of the orientation of the passage. The filter 700 can be associated with one of the openings 610, 620 of the fluid flow passage 600 into the wells 200, 300. For example, FIG. 3B shows the filter 700 disposed at the opening 610 of the fluid flow passage 600 to the mother well 200. The filter 700 in FIG. 3B is secured to a side of the mother well 200 and not within the fluid flow passage 600. FIG. 3C shows the filter 700 disposed at the opening 620 of the passage 600 to the daughter well 300. The filter 700 in FIG. 3C is secured to a side of the daughter well 300 and not within the passage 600. These embodiments may be varied or combined without departing from the scope and spirit of the invention.

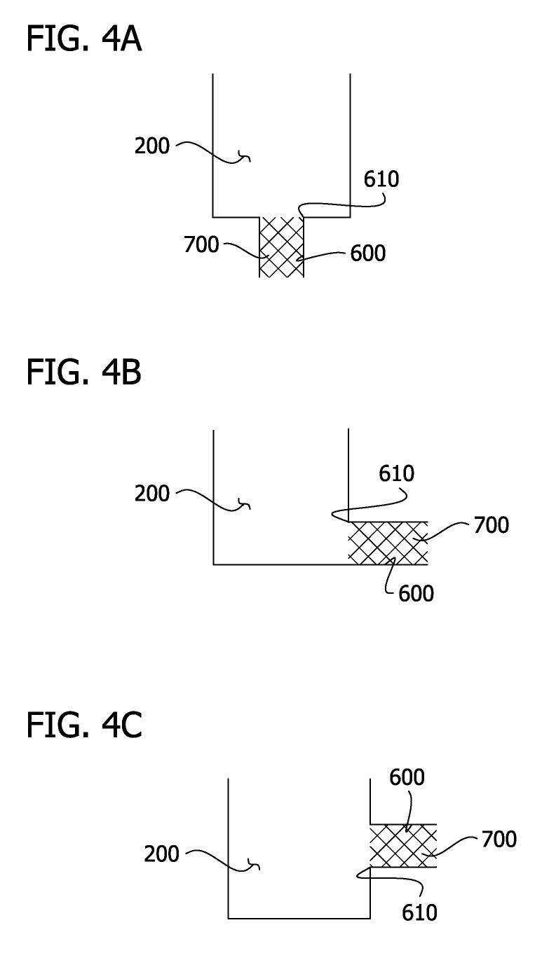

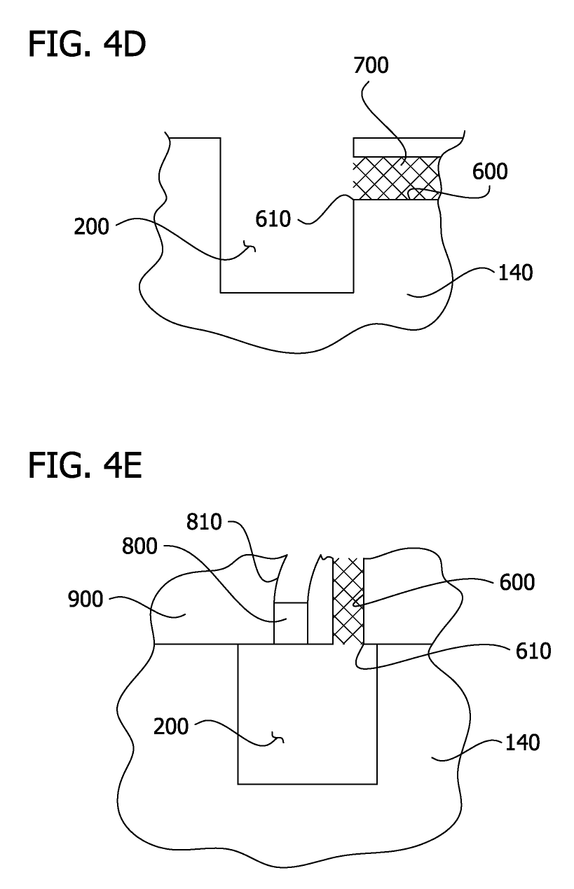

FIGS. 4A-4E show several examples for possible locations of the openings 610, 620 of the fluid flow passage 600 in the wells 200, 300. For convenience, FIGS. 4A-4E use the mother well 200 to illustrate possible locations of the opening 610 to the mother well. It is understood that these possible locations are equivalently applicable to the openings 620 into the daughter well(s) 300. FIG. 4A shows the opening 610 in the bottom of the mother well 200. FIG. 4B shows the opening 610 in the side of the mother well 200 and at the bottom of the mother well. FIG. 4C shows the opening 610 in the side of the mother well 200 and at a level above the bottom of the well, but not at the top of the well. FIG. 4D shows the opening 610 in the side of the mother well 200 and generally at the level of the top of the well.

FIG. 4E shows a mother well 200 having a removable top 900 for covering and sealing an open end of the mother well. A tube 810 extends through the top 900 into the well 200. A valve 800 in the tube 810 selectively permits or blocks flow of fluid into or out of the well 200 through the tube. The fluid flow passage 600 extends through the top 900 adjacent the tube 810 such that the opening 610 of the passage is at the top of the mother well 200. In order to get fluid to flow from the mother well 200 into the fluid flow passage 600 for distribution to the daughter well(s) 300 an immiscible higher density fluid can be added to the mother well to displace the fluid that is to be distributed from the mother well.

The location of the openings 610, 620 within the wells 200, 300 can be important in the context of whether the entire contents of a well are to be drained through the opening. Positioning the opening in or at the bottom of a well makes it possible to drain substantially all liquid from the well through the opening. Placing an opening in the side of a well above the bottom provides a convenient way to retain a quantity of liquid in the well below the opening after a quantity of liquid at and above the level of the opening has been drained through the opening.

Although the access ports 400 and 500 in FIG. 2 are open tops to the respective wells 200, 300, it is also possible to seal the wells (e.g., with a removable top cover 900 or other sealing device). Further, if desired sealable access ports 400, 500 can be integrated into the top cover 900 or other sealing device to provide access to the wells 200, 300 while they are maintained in their sealed condition. The ability to seal the wells 200, 300 enables the creation of a sealed environment, capable of containing pressures up to several atmospheres, which can limit evaporation of a solvent or other liquid. Sealing the wells can also facilitate heating of the components to enhance dissolution. A combination of closed tops and sealable access ports can also provide for independent pressurization or evacuation of any well and can enable creation of a pressure differential between various wells (e.g., to force fluid to flow between the reactors).

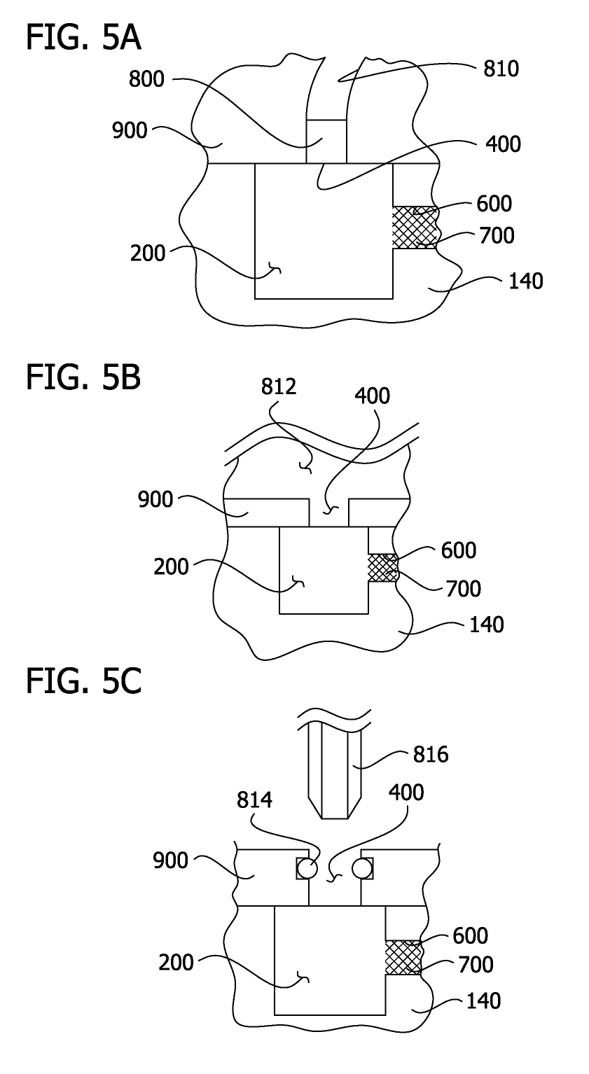

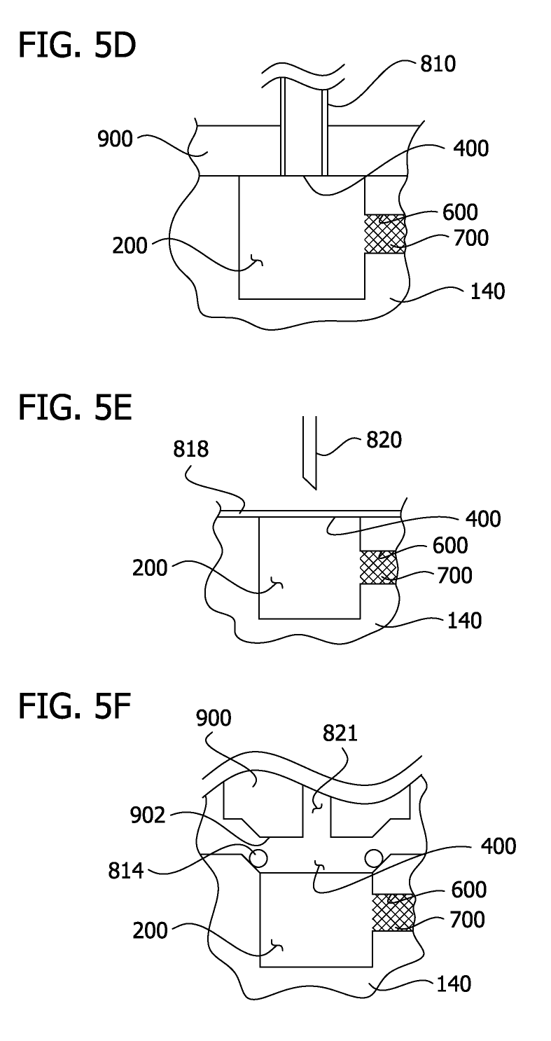

FIGS. 5A-5F shows several different examples of sealable access ports that can be used for the mother well and daughter well(s). For convenience, FIGS. 5A-5F illustrate sealable access ports 400 only in the context of the mother well 200, but the sealable access ports 500 for the daughter well(s) 300 can be made in the same manner. FIGS. 5A-5F also show the access ports 400 disposed at the top of the mother well 200, but the access ports 400, 500 can instead be disposed in the side or bottom of the respective well 200, 300 within the scope of the invention.

FIG. 5A shows a removable top 900 sealing the access port 400 at the open end of the mother well 200. A conduit 810 (e.g., tube) extends through the top 900. A valve 800 in the conduit 810 selectively allows passage of fluid through the conduit or blocks flow of fluid through the conduit to seal the access port 400. When the valve 800 is open, the tube 810 can deliver liquids or gases to the well 200 and can also aspirate materials from the well 200.

In FIG. 5B, the access port 400 is an hole extending through the top 900 on the mother well 200. The access port 400 is in fluid communication with a fluid supply system (e.g., a manifold 812) operable to pressurize the well 200 to a pressure different from an ambient pressure and/or provide materials required to create a desired environment in the well.

In FIG. 5C the access port 400 is a hole in the top 900. The top 900 includes a sealing member 814 (e.g., an O-ring) capable of forming a seal between the top and a moveable insert tube 816 (e.g., a cannula). The insert tube 816 can be disposed at any vertical position within the well 200, while maintaining the seal. The insert tube 816 is suitably sufficiently rigid that it can be inserted through the access port 400 without damage, and is capable of delivering or aspirating liquids or gases to or from the well 200. It may be advantageous to use an automated robotic system to operate insert tube 816, including moving the tube to one of the reactors 102, moving the tube vertically into and out of the wells 200, 300, and any aspiration and/or dispense cycles.

In FIG. 5D the access port 400 is an opening extending through the top 900. The access port 400 is in fluid communication with a tube 810 connected to a fluid supply system operable to pressurize the well 200 to a pressure different from an ambient pressure and/or provide materials required to create a desired environment in the well.

FIG. 5E shows a septum 818 sealing the access port 400 at the top of the well 200. The septum 818 is capable of being pierced by a needle 820. Once the needle has pierced the septum 818, the needle 820 can be positioned at any vertical position in the well. The needle 820 is also operable to deliver or aspirate liquids or gases to or from the well 200. It may be advantageous to use a septum 818 that remains sealed (both to the well 200 and the needle 820) against fluid passage when pierced. It may also be advantageous to use a septum 818 that reseals itself after it has been pierced by the needle 820 and the needle has been withdrawn. Further, an automated robotic system can be used to operate the needle 820, including moving the needle within the reactor system 100, moving the need between wells, moving the needle vertically within a well, and any aspiration and/or dispense cycles.

In FIG. 5F the side of well 200, at the top, is shaped to receive a sealing member 814 (e.g., an O-ring). The top 900 is shaped so a portion of the top seals against the sealing member 814 when the top is vertically pressed onto the top of well 200. For example, the top 900 illustrated in FIG. 5F can include a protrusion 902 that can be inserted part of the way into the well 200 to engage the sealing member 814. The top 900 includes a hollow passageway 821, capable of delivering or aspirating liquids or gases to or from well 200. The passageway 821 may optionally be integrated with other fluid control apparatus, such as a valve 800 (as illustrated in FIG. 5A) or a manifold 812 (as illustrated in FIG. 5B). It may be advantageous to fabricate selected access ports using methods and apparatus typical of semiconductor manufacturing.

The sealable access ports 400, 500 can be part of a pressurization system along with the valves 800, conduits 810, and/or manifold 812 (or the like). The pressurization system is suitably operable to pressurize any of the reactors 102 (or any of the wells 200, 300 within a reactor) to a pressure different (e.g., greater than) an ambient pressure. The pressurization system is also suitably operable to establish a relative pressure differential between any of the wells 200, 300 (e.g., to force fluid to flow between the wells).

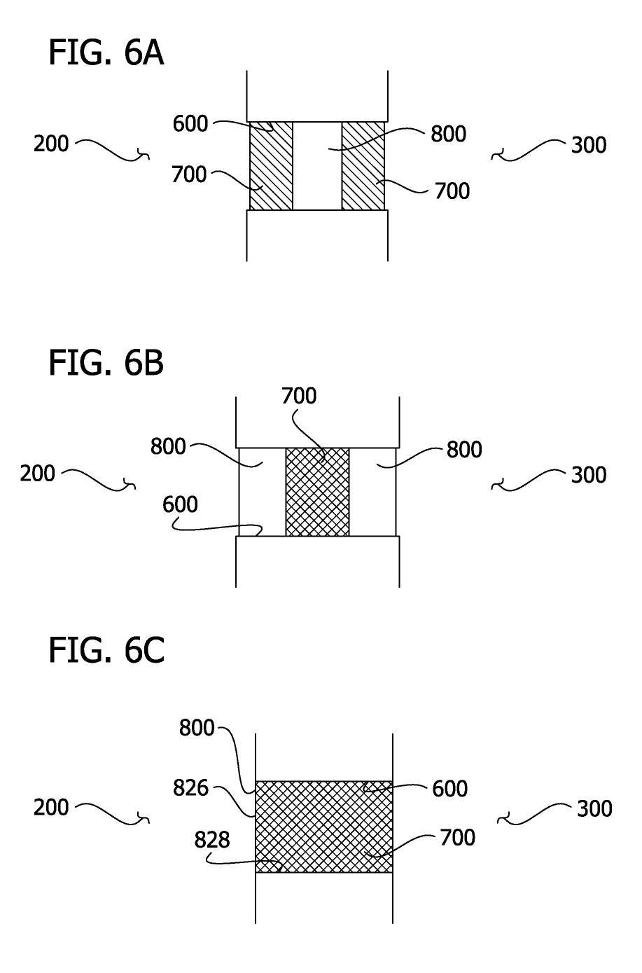

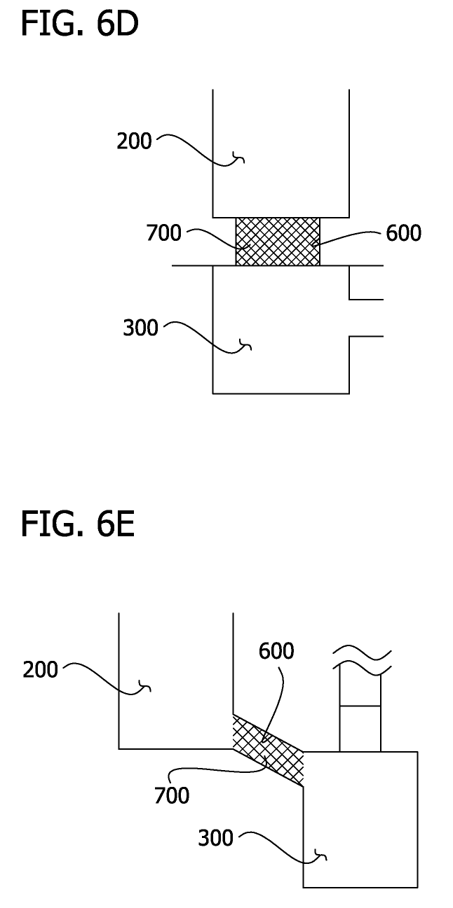

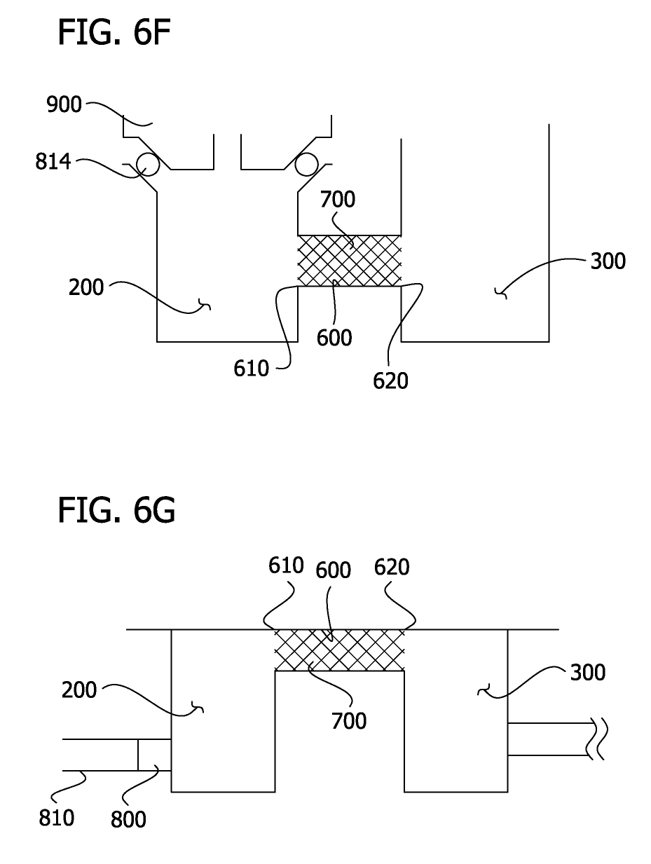

FIGS. 6A-6G show several examples of flow control devices that can be included in the fluid transfer system 150 to control fluid flow between the wells 200, 300. FIG. 6A shows a valve 800 disposed in the fluid flow passage 600. Filters 700 are disposed on both sides of the valve 800 in FIG. 6A, but it may be advantageous to use a filtering mechanism that does not include a filter on one of the sides of the valve. FIG. 6B shows two valves 800 in the passage 600. One of the valves 800 is disposed at the opening 610 to the mother well and the other valve is disposed at the opening 620 to the daughter well. A filter 700 is positioned in the fluid flow passage 600 between the valves 800.

For the sizes of samples used in the reactor system 100, the effects of surface tension on liquids can be appreciable. The flow control device illustrated in FIG. 6C relies on surface tension to control flow. The flow control device 800 includes a surface 826 of the filter 700 that is non-wetting to a liquid that may be dispensed in either of the wells 200, 300. For example, the surface 826 of the filter can comprise Teflon®, which is non-wetting for many different fluids. The flow control device 800 also includes an inner surface 828 of the fluid flow passage 600 that is non-wetting to a liquid that may be dispensed in either well. For example, a Teflon® liner or coating can be used to form the inner surface 828 of the passage 600 to provide a non-wetting surface. When the wells 200 and 300 are at the same pressure, surface tension of the liquid prevents flow of liquid between the wells. With the creation of a sufficient pressure differential between the wells 200, 300 (e.g., by pressurizing one of the wells or changing the elevation of one of the wells relative to the other), fluid can be forced through fluid flow passage 600, overcoming the surface tension. Also flow through the passage 600 can be stopped by removing the pressure differential. Although the flow control device 800 in FIG. 6C includes a non-wetting surface 826 of the filter 700 and a non-wetting surface of the passage 600, either can be used without the other within the scope of the invention.

For experimental protocols in which gaseous communication between the mother well 200 and daughter well(s) 300 is acceptable, the fluid transfer system 150 can use the spatial relationship between wells in combination with gravity to control flow of liquid, optionally in combination with the surface tension as described above in connection with FIG. 6C. For example, FIG. 6D shows a mother well 200 disposed above a daughter well 300. The wells 200, 300 are connected by a vertical fluid flow passage 600 enclosing a filter 700. While liquid can flow from mother well 200 to daughter well 300, gravity prevents liquid from flowing in the reverse direction. This combination of spatial relationship and gravity controls flow of liquid in the reactor 102 by preventing flow of liquid from the daughter well 300 to the mother well 200. FIG. 6E shows another example of how the spatial relationship between the daughter well 300 and mother well 200 allows liquid flow in one direction under the influence of gravity, but does not allow liquid flow in the other direction, thereby controlling flow in the reactor. In FIG. 6E, the mother well 200 is at an elevated position relative to the daughter well 300. The fluid flow passage 600 extending between the wells 200, 300 contains the filter 700 and is inclined to prevent flow of liquid from the daughter well to the mother well.

In FIG. 6F, the fluid transfer system relies at least in part on positioning of the openings 610 and 620 of the fluid flow passage 600 to control flow of fluid in the reactor 102. The openings 610, 620 are disposed part way up the sides of wells 200 and 300, respectively. The removable top 900 can seal to sealing member 814 and deliver liquids or gases to the mother well 200. If the mother well 200 contains sufficient liquid so the upper surface of the liquid is above the opening 610, inert gas can be used to pressurize the mother well and thereby force some of the liquid through fluid flow passage 600 into the daughter well 300. However, when the level of liquid in the mother well 200 reaches the level of the opening 610, liquid flow through fluid flow passage 600 will be replaced by gas flow through fluid flow passage 600. By choosing the volume of the daughter well 300 to be large enough to contain all the transferred liquid in the part of the well below the level of opening 620, reverse flow from the daughter well to the mother well is prevented. This facilitates retention of a substantial amount of solution in the mother well 200 while still delivering a substantial amount of solution to the daughter well 300.

In FIG. 6G, the fluid transfer system 150 includes a fluid flow passage 600 extending between the wells 200, 300 and having openings 610, 620 above the bottoms of the respective wells (e.g., at the tops, as illustrated). When oriented in the manner illustrated, liquid present in one well (e.g. well 200) is prevented from passing to the other well (e.g. well 300) through the passage. Inverting the reactor, so the fluid flow passage 600 is disposed below the level of the liquid in the well (e.g., at the bottom of the wells) allows liquid to flow between the reactors via the passage 600. For example, if necessary a valve 800 in the tube 810 can be opened to pressurize the mother well 200 and create a pressure differential forcing the liquid through the filter 700 into the daughter well 300. Re-inverting (i.e., restoring the reactor to the orientation of FIG. 6G) stops flow of liquid between the wells 200, 300.

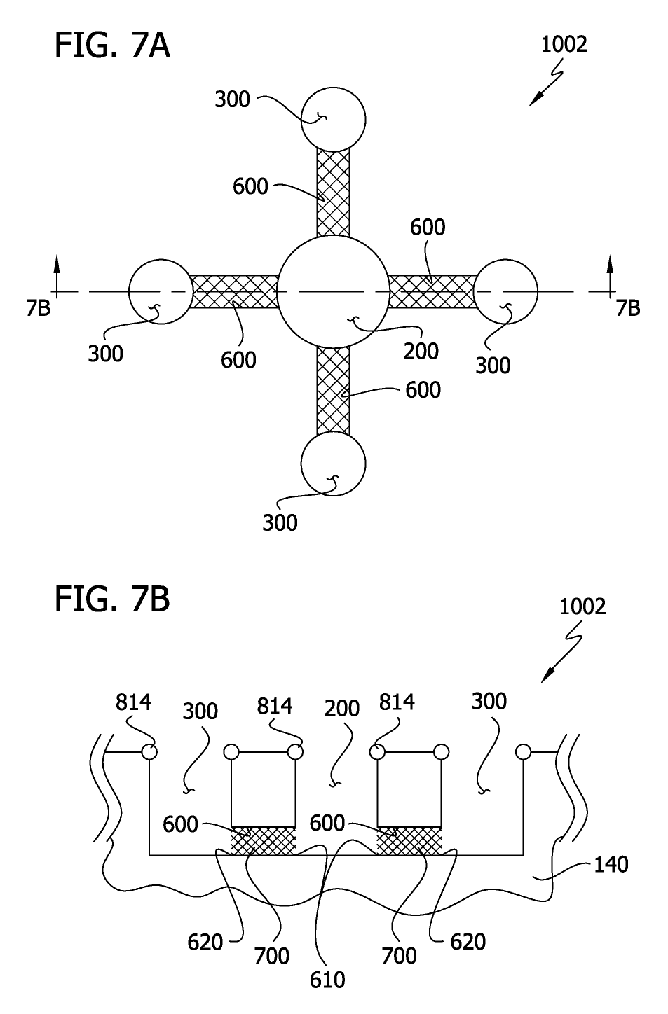

FIGS. 7A and 7B show a reactor 1002 comprising a mother well 200 serving four daughter wells 300. Each daughter well 300 in FIGS. 7A and 7B is served by a separate fluid flow passage 600 extending to the mother well. However, it is understood that the daughter wells could be supplied via a network of fluid flow passages (including one or more interconnected passages) within the scope of the invention. As illustrated, the reactor 1002 has four daughter wells 300 disposed laterally from the mother well 200 (e.g., in substantially the same plane as the mother well). For example, the wells 200, 300 of the reactor 1002 can suitably be formed in a common substrate 140 (e.g., a semiconductor wafer). The daughter wells 300 in FIGS. 7A and 7B are positioned at different radial positions relative to the mother well 200. Each daughter well 300 is in fluid communication with the daughter well by its respective fluid flow passage 600. As illustrated in FIG. 7B the openings 610, 620 of the fluid flow passages 600 are disposed in the side of their respective well 200, 300 at the level of the bottom of the well. The wells 200, 300 suitably also include o-rings 814 (FIG. 7B), capable of engaging one or more removable tops 900 to seal the wells in substantially the same way illustrated for one well in FIG. 5F.

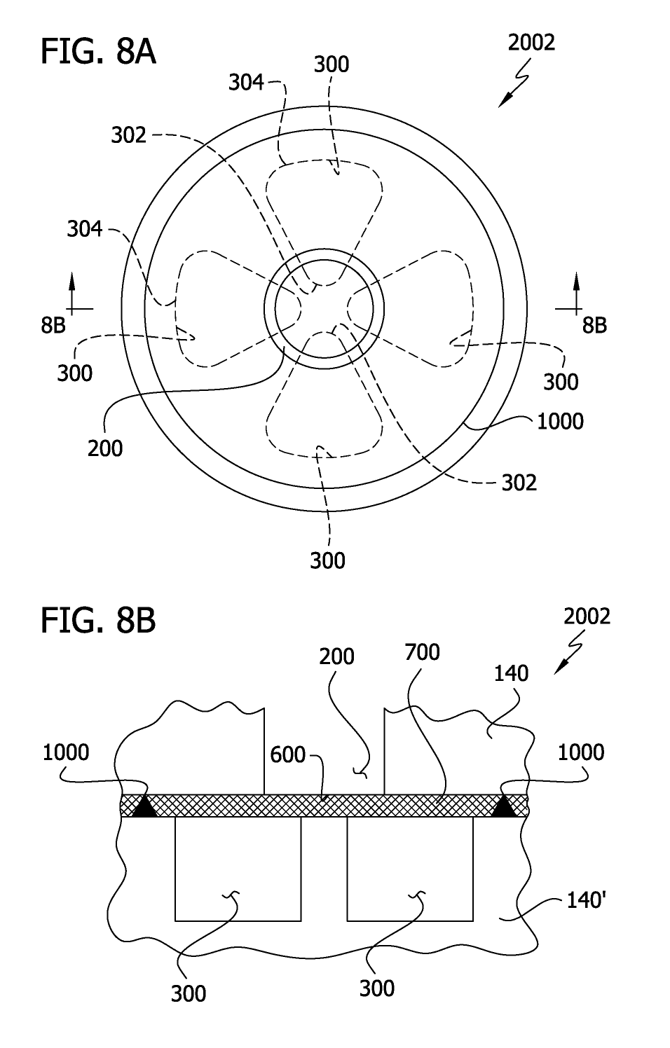

FIGS. 8A and 8B illustrate a reactor 2002 having a mother well 200 and four daughter wells 300. The daughter wells 300 are disposed below the mother well 200, as illustrated in FIG. 8B. The mother well 200 is suitably an open bottomed well while the daughter wells 300 have open tops. As illustrated in FIG. 8A, at least a portion of each daughter well 300 is beneath a portion of the mother well so such that the overlap of the open bottom of the mother well 200 and the open tops of the daughter wells 300 forms fluid flow passages 600. As illustrated in FIG. 8A, the daughter wells can suitably be configured to have relatively narrower portions 302 positioned under the mother well 200 and relatively wider portions 304 opposite the narrower portions. This can facilitate arranging multiple daughter wells 300 so a portion of each daughter well is beneath the mother well 200. The mother well 200 is suitably formed in one substrate 140 (e.g., a first semiconductor wafer) while the daughter wells 300 are formed in a different substrate 140′ (e.g., a second semiconductor wafer). A filter layer 700 is positioned between the substrates 140, 140′ so fluid flowing in the passages 600 is required to flow through the filter. A barrier 1000 (e.g., knife edge that cuts into or at least crimps the filter layer) extends around the perimeter of the reactor 2002 to limit cross contamination between adjacent reactors via wicking or other transport of fluid laterally in the filter layer 700.

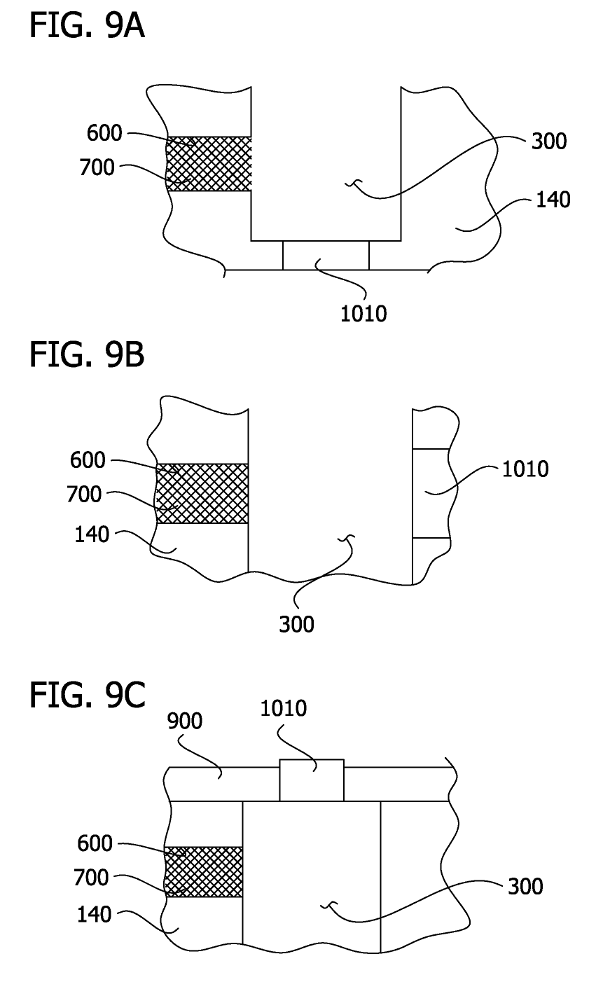

It can be advantageous to analyze materials (e.g., samples) within the reactors (e.g., in the daughter wells 300). Radiation, such as visible light, infrared, ultraviolet, x-rays or other radiation can be a convenient way to analyze the materials. Thus, the containment structure defining any well can optionally include a region or window of sufficient transparency to a desired radiation that analysis with radiation is possible through the window. FIGS. 9A-9C show several possible examples in which a portion of a well is substantially transparent to radiation. These examples use daughter wells 300, but the windows can be provided in the same way for the mother wells. FIG. 9A shows a substantially radiation transparent window 1010 disposed at the bottom of the well 300. In FIG. 9B the window 1010 is in the side of well 300 and in FIG. 9C the window 1010 is in a top 900 (e.g., a removable top) of the well 300.

“Substantial” radiation transparency can be created by using a window made of a material that is intrinsically transparent to the radiation of interest. It is also possible to make a substantially transparent window out of a material that is generally not considered intrinsically transparent to the radiation by making the window sufficiently thin to allow a sufficient amount of the radiation to pass through the window.

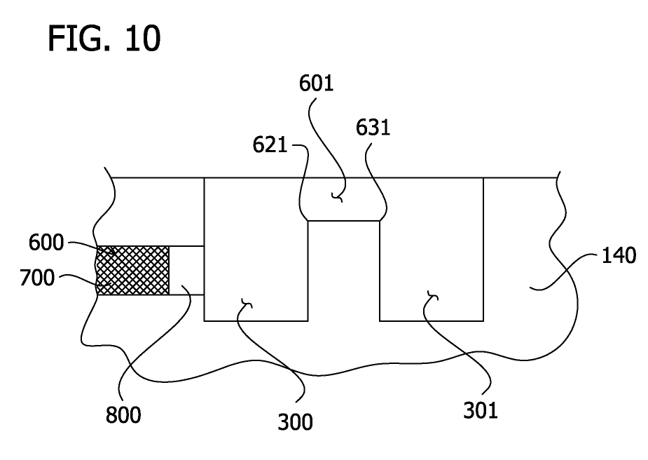

It may be advantageous to create various combinations of wells within the same reactor. One possible combination is shown in FIG. 10, which includes a diffusion well 301 in communication with a daughter well 300 via diffusion fluid flow passage 601. The openings 621, 631 of the diffusion fluid flow passage 601 are disposed at a distance above the bottom of the wells 300, 301 sufficiently large that fluid can be disposed in either or both wells without resulting in fluid transport between the wells though the diffusion flow passage. For example, the openings 621, 631 can be disposed at the top of the wells 300, 301 as illustrated in FIG. 10. The wells 300, 301 remain in gaseous communication because of the fluid flow passage 601. This allows the diffusion of a gaseous component between the wells (e.g., from the diffusion well 301 to the daughter well 300). Although FIG. 10 does not show any filter associated with the diffusion fluid flow passage 601, it is recognized that a filter can be included if desired (e.g., to limit the rate of diffusion of a component from the diffusion well to the daughter well).

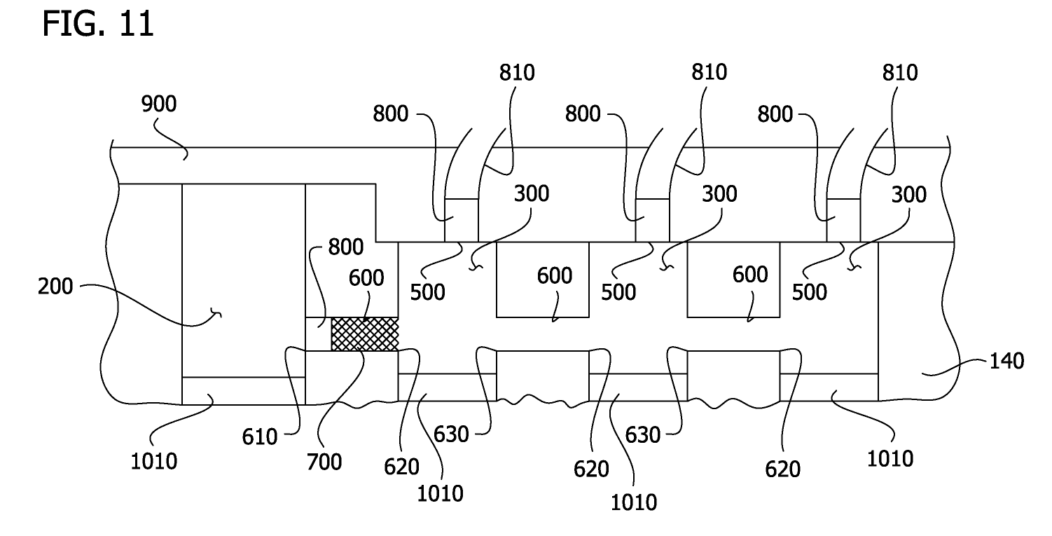

Another possible combination of wells is illustrated in FIG. 11 and includes three daughter wells 300 connected in series with the mother well 200 by fluid flow passages 600. A filter 700 and valve 800 are positioned in the fluid flow passage 600 between the mother well 200 and the daughter wells 300 to purify fluid transferred to the daughter wells and control flow of fluid from the mother well to the daughter wells, respectively. The fluid flow passage opening 610 leading out of the mother well 200, the fluid flow passage openings 620 into the daughter wells 300, and the fluid flow passage openings 630 leading out of the daughter wells are disposed a short distance (e.g., about 10 percent of the height of the daughter wells) above the bottoms of the wells. Accordingly the openings 610, 620, 630 are positioned to retain a portion of the fluid in the mother well 200 and in each of the daughter wells 300 when the fluid is distributed from the mother well through the fluid flow passages 600. A removable top 900 suitably extends over and seals the open tops of the wells 200, 300. Valves 800 in the top 900 control flow through the access ports 500 of the daughter wells 300 and can be opened to place the daughter wells 300 in communication with conduits 810. For example, the conduits 810 can be used to aspirate from the daughter wells 300 (e.g., to create a pressure differential to force fluid to flow from the mother well into the daughter wells 300). The conduits 810 can be used to add materials to the daughter wells. The mother well 200 and each daughter well 300 suitably have a window 1010 that is substantially transparent to radiation to facilitate analysis of materials in the wells.

The reactor system 100 suitably includes a controller, such as a PC or other processor, that is operable to control operation of the valves 800 and other components of the fluid transfer system 150 to pressurize the wells 200, 300 and/or control flow of fluid within the reactors 102. The controller can suitably also control a robotic system (e.g., to move a removable top 900, move a needle 820, and/or perform other operations associated with a dissolution and precipitation protocol automatically).

A method for dissolving, precipitating and analyzing a series of solids can comprise the delivery of small quantities of solids to each of the reactors 102. Each mother well 200 receives a first solid and a first solvent. Each reactor 102 may receive the same first solid or some or all of the reactors may receive different first solids. Similarly, each reactor may use the same first solvent or some or all of the reactors may receive different first solvents. Further, any of the first solvents can be a combination of multiple solvents. Each reactor can then be optionally sealed (e.g., using a removable top 900 or septum 818 as described above) and heated and/or stirred to dissolve the first solids in the first solvents to form solutions.

The fluid transfer system 150 is used to distribute a fluid (e.g., the solution prepared in the mother well 200) to the one or more daughter wells 200. For example, the fluid transfer system 150 may open one or more valves 800 and/or create a pressure differential between the mother well 200 and the one or more daughter wells 300 to cause the fluid to flow into the daughter wells 300. The fluid transfer system 150 purifies the fluid distributed to the daughter wells in the reactor (e.g., by filtering the fluid as it flows to the daughter wells 300). If desired, some of the fluid can be retained in the mother well 200 using the structures described above.

The mother and daughter wells 200, 300 can then be subject to different (or the same) precipitation protocols to precipitate second solids in the reactor 102. The quantity of second solids precipitated in each well 200, 300 is suitably less than about 0.25 mg. Addition of a component (e.g., through the access ports 400, 500) that acts as an anti- solvent, evaporation of the first solvent, or slow addition of a component (e.g. through a diffusion fluid flow passage 601) may be used to precipitate a second solid from the solution. Cooling, isothermal or other thermal protocols may also be used to cause precipitation of a second solid. A variety of other protocols may also be used to precipitate a second solid in any of the mother or daughter wells 200, 300.

Any of the second solids can then be analyzed without removing the solids from the reactor 102 using radiation, such as visible, infrared, ultraviolet, x-ray, or other types of radiation. For example, the radiation can be transmitted through one or more windows 1010 in each well 200, 300 that is substantially transparency to the radiation.

For an experimental protocol in which each solution is subjected to multiple different precipitation conditions, it may be efficient to use a reactor in which a single mother well 200 provides solution for two or more (e.g., several) daughter wells 300, and each daughter well is subjected to a different precipitation protocol to assess the impact of the precipitation protocols on the solids precipitated thereby.

When introducing elements of the invention, the articles “a”, “an”, “the” and “said” are intended to mean that there are one or more of the elements. The terms “comprising”, “including” and “having” and variations thereof are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A dissolution and precipitation system comprising an array of reactors, each reactor comprising:
a mother well;
a daughter well having a volume between about one microliter and one milliliter; and
a fluid transfer system operable to transfer fluid between the mother well and daughter well and purify the fluid that is transferred to the daughter well from the mother well.

2. A dissolution and precipitation system as set forth in claim 1 wherein the fluid transfer system includes a fluid flow passage extending between the mother well and the daughter well and a filter positioned in the fluid flow passage.

3. A dissolution and precipitation system as set forth in claim 1 wherein the fluid transfer system is operable to purify the fluid without removing the fluid from the reactor.

4. A dissolution and precipitation system as set forth in claim 1 wherein the daughter well is a first daughter well, the system further comprising one or more additional daughter wells having volumes between about one microliter and one milliliter, respectively, the fluid transfer system being operable to distribute the fluid from the mother well to each of the daughter wells and purify the fluid transferred to each of the daughter wells.

5. A dissolution and precipitation system as set forth in claim 4 wherein each of the daughter wells is defined by a containment structure, at least a portion of the containment structure being substantially transparent to a radiation to facilitate analysis of a material in the respective daughter well using the radiation.

6. A dissolution and precipitation system as set forth in claim 5 wherein the mother well is defined by a containment structure, a portion of the containment structure being substantially transparent to a radiation to facilitate analysis of a material in the mother well using the radiation.

7. A dissolution and precipitation system as set forth in claim 1 wherein the reactors are formed in a wafer.

8. A dissolution and precipitation system as set forth in claim 1 wherein the fluid transfer system comprises a fluid flow passage extending between the mother well and the daughter well and a valve operable to control flow through the fluid flow passage.

9. A dissolution and precipitation system as set forth in claim 1 wherein the fluid transfer system comprises a pressurization system for selectively adjusting a relative pressure differential between the mother well and the daughter well to transfer fluid between the mother well and the daughter well.

10. A dissolution and precipitation system as set forth in claim 1 wherein the reactors are sealed.

11. A dissolution and precipitation system as set forth in claim 10 wherein the sealed reactors have one or more access ports each for transferring materials between an exterior of the reactor and an interior of the reactor while maintaining the sealed condition of the respective reactor.

12. A dissolution and precipitation system as set forth in claim 10 further comprising a pressurization system operable to pressurize the reactors to a pressure greater than an ambient pressure.

13. A dissolution and precipitation system as set forth in claim 1 wherein at least one reactor further comprises a diffusion well and a fluid flow passage extending between the daughter well and the diffusion well, the fluid flow passage being spaced from a bottom of the daughter well.

14. A dissolution and precipitation system as set forth in claim 1 wherein the mother well has a volume between about one microliter and one milliliter.

15. A dissolution and precipitation system as set forth in claim 1 wherein the fluid transfer system is operable to transfer only a portion of the fluid to the daughter well such that a sample of the fluid is retained in the mother well.

16. A method of testing a plurality of samples in a plurality of reactors, each reactor comprising a mother well and one or more daughter wells adapted to receive a fluid from the mother well, the method comprising:
dissolving a plurality of first solids in each of the mother wells to form a plurality of first solutions in the mother wells;
purifying at least portions of the first solutions in the reactors;
distributing the first solutions from the mother wells to one or more daughter wells, wherein the one or more daughter wells have a volume between about 1 microliter and 1 milliliter, respectively;
precipitating a plurality of second solids in the daughter wells; and
analyzing the second solids.

17. A method as set forth in claim 16 wherein the purifying comprises filtering the first solutions in the respective reactors.

18. A method as set forth in claim 16 wherein the analyzing comprises using radiation to analyze the second solids while they are in the daughter wells.

19. A method as set forth in claim 16 wherein the distributing comprises retaining a portion of said first solutions in the respective mother well, the method further comprising analyzing a material associated with the retained solution while the material is in the mother well.

20. A method as set forth in claim 16 wherein each reactor comprises at least two daughter wells in fluid communication with the mother well.

21. A method as set forth in claim 16 wherein the precipitating comprises precipitating no more than about 0.25 mg of said second solids in each of the daughter wells.
